(19) United States
(12) Patent Application Publication
(10) Pub. No.: US 2012/0030139 A1
(43) Pub. Date: Feb. 2, 2012

(54) FINANCIAL EDUCATION PLANNER AND METHOD OF USE THEREOF

(76) Inventor: Fan WANG Yiang, Palm Gardens (SG)

(21) Appl. No.: 13/263,138

(22) PCT Filed: Mar. 11, 2010
(86) PCT No.: PCT/SG10/00088

§ 371 Date: Oct. 6, 2011

(30) Foreign Application Priority Data
Apr. 16, 2009 (SG) 200902581-8

(51) Int. Cl. G06Q 40/00

(52) U.S. Cl. 705/36 R; 705/500

(57) ABSTRACT

A financial educational planner is disclosed for imparting basic lessons on financial management and, over mid to long term, to develop the savings habit. The planner allows a user to watch how the money is earned, spent and saved, and how the money saved grows due to interest, bonus and investments. Most importantly, the planner is used to guide the user to manage and plan the money to afford the desired items or life-style in the future. The planner comprises an expense account worksheet (14), a savings account worksheet (16) and a plurality of tokens (18) representing monetary denominations. The tokens (18) are affixable on the worksheets having a layout which may be provided with boxes or cells representing periodic units for affixing the tokens (18). Specially-marked boxes (20) may be provided at predetermined intervals on the worksheet (16) to allow for rewards.

### FIELD OF INVENTION

This invention relates to a planner for educating a user, including children, in resource savings such as monetary or financial savings, as well as in learning the benefits therefrom. This habitual activity is performable on a physical or electronic worksheet. A method of using such planner is also disclosed.

### BACKGROUND ART

There exist a number of worksheets or devices for providing education on planning or accounting for financial resources such that the expenditure and savings of money may be planned, budgeted or habitually cultivated. An early, pre-World War II example is U.S. Pat. No. 2,230,699 (Shulze) which was granted in 1941. This prior art teaches a budget game board having slots for inserting money-representing tokens therein and separated into “Food”, “Shelter”, “Clothing”, “Operating Expenses”, “Savings” etc.

U.S. Pat. No. 4,336,019 (Schroder) discloses a game board for playing with accounting entries made on an accounting board for teaching the rudiments of double entry may be considered a simple example. Some prior art however, desiring to reflect the actual financial environment, have more complicated arrangements such as that disclosed in U.S. Pat. No. 6,767,210 (Joffe) wherein the entire component accounts of a business balance sheet and income statement are involved for the user to engage in.

For engaging children in such exercises, a different educational arrangement may be necessary with the purpose of infusion of young minds. U.S. Pat. No. 3,992,805 (Arkin) discloses a piggy bank in the shape of a bird nest comprising separate bird figures with coin slots and drawers for spending, saving and sharing as simple way of allocating pocket money. A more sophisticated piggy bank is disclosed in U.S. Pat. No. 5,716,211 (Vetter) in which deposits into the different slots for “spending”, “college”, “home” and “retirement” is electronically tabulated with electronic budgetary advisory for investment.

Page sheets or worksheets forms of educational planners are disclosed in U.S. Pat. No. 6,224,381 (Culberson). This prior art's display page is actually a magnetic board for holding tokens representing monetary, budgetary or investment values. PCT Published Application No. WO 2006/076266 (DaSilva) discloses an elaborate money management education software application which may be supported in part by a website providing relevant financial information.

### SUMMARY OF DISCLOSURE

It is desirable that a financial educational planner be provided to impart basic lessons on financial management to persons of all ages including young children, and imbue in them the good habit of saving a portion of their income that can only be used for investment purposes. Once the money is allocated to the saving account, the money cannot be used for any expenses or gifts. It is further desirable that the planner would serve as a mid to long term guide to money management to allow a user to monitor the income and expenses and watch the savings grows as a result. The objective of the planner is to guide the user to plan his expenses and savings, so as to afford the items and life-styles the user desires in the future.

To this end, we now propose a financial education planner comprising at least a income worksheet, at least an expense account worksheet; at least a savings account worksheet; and a plurality of tokens representing monetary denominations, said tokens being affixable on aforesaid worksheets, wherein said expense account worksheet and savings account worksheet having numbered boxes or cells, in a layout, enabling affixing of said tokens thereunto on a periodical basis.

In one aspect of the invention, the expense and savings accounts worksheets' tabular layout or calendar layout includes boxes or cells for affixing of said tokens. The boxes or cells can be numbered or represents periodical units. Specially-marked boxes are preferably provided at predetermined intervals on the worksheet. The worksheets preferably includes date, activity description, income, totals for expenses and savings, bonus and the like, in the same columns where the tokens are placed or in a separate list.

In a second aspect, the tokens may be indicated with a suitable monetary denomination and optionally provided with an iconic feature. The tokens can be in a form of adhesive labels that are of different colours or designs to identify the intended designated accounts. For example, if the intention is to save 10% of the money into savings account, every 1^{st} or 10^{th} token received by the user is the special saving token that can only be affixed to the saving account worksheet. Alternatively, the tokens are provided as bubble or blister which burst with a sound and/or visual and/or feel effect when punctured.

The adhesive labels or bubble/blister must be marked or burst when the tokens are spent or lost (in expense and saving account worksheet). All expenses and investments should be recorded in the worksheet together with the tokens, or on separate list, to record how the money is used. The user can monitor his or her progress, and learn and improve his money management skills. Preferably, upon the number of tokens accumulated on the savings account worksheet reaches a predetermined threshold, investment options for said accumulated tokens becomes available.

In one preferred embodiment of our financial education planner, additional worksheets are included to provide for breakdown of the expenses including any one or combination of gifts account, education account, long-term savings account, entertainment or luxury account and the like.

In a third aspect, our financial education planner may be provided as a virtual, web page-based or electronic form including electronic table or worksheet, page file, applet and like routines. Preferably, the investment options include hyper-linking to web-pages containing advisory and information on said investment options.

In one aspect of our method, not more than 90% of the income is allocated to the expense account with the balance of not less than 10% of the income allocated to the savings account. Preferably, more than 10% of the income is allocated to the savings account.

In a second aspect of our method, reward in the form of bonus issue of additional tokens is provided upon accumulated savings reaches a predetermined amount as indicated on the worksheet at periodic intervals. Preferably, reward in the form of interest is provided in the form of additional tokens based upon accumulated savings having been retained for predetermined periodic intervals of the worksheet.

In a third aspect, options for investment are provided upon the accumulated savings represented by the number of tokens affixed to the savings account worksheet attains a predetermined threshold. In one alternative, the rewards are not disclosed to the person until the predetermined threshold is reached. Preferably, reward in the form of approved purchase of a product or service that is desired by the person is enabled once a predetermined amount of tokens is saved.

### LIST OF ACCOMPANYING DRAWINGS

Other advantages and features of our invention may become more apparent upon perusal of the following detailed description when taken in conjunction with the following drawings which show non-limiting exemplary, specific or preferred embodiments of our invention.

FIG. 1 shows a sheet for listing out money or income generating activities. This may preferably be preceded by compiling a list of all activities such as shown in FIG. 1A as a Year Planner. FIG. 1B depicts an example of an income worksheet.

FIG. 2 illustrates a sheet for listing out expense items.

FIG. 3 depicts an expense account worksheet with tokens affixed according to our invention.

FIG. 4 exemplifies a savings account worksheet with tokens affixed according to our invention, and FIG. 4A shows a Wish List of objectives to be achieved by the saving effort.

FIG. 5 exhibits an example of bonus cards according to our invention.

FIG. 6 presents a sheet for listing out investment opportunities and

FIG. 6A shows an example of a bonus card for investment opportunity.

FIG. 7 represents another example of a worksheet in calendar layout form; and

### DETAILED DESCRIPTION OF SPECIFIC EMBODIMENTS

The habit of reserving some of one's resources is well-known to be a virtue since ancient times although in the present globalised financial system and economy, cultivation of such virtue is being taken more seriously in the face of unbridled consumption, material temptation and easy availability of credit. The portion to be reserved or saved may vary for an individual and at different times but putting aside 10% of one's earning has been made a popular one by many advisors and books on financial prudence such as the 1926 publication, The Richest Man in Babylon by George Samuel Clason which was republished by Signet in 2004. Hence, in this specification, we will be using the 10% as the example of the minimum portion to be saved although it is obvious that any other percentage may also be applicable with our invention. In fact, it is preferable that the savings rate is more than 10%.

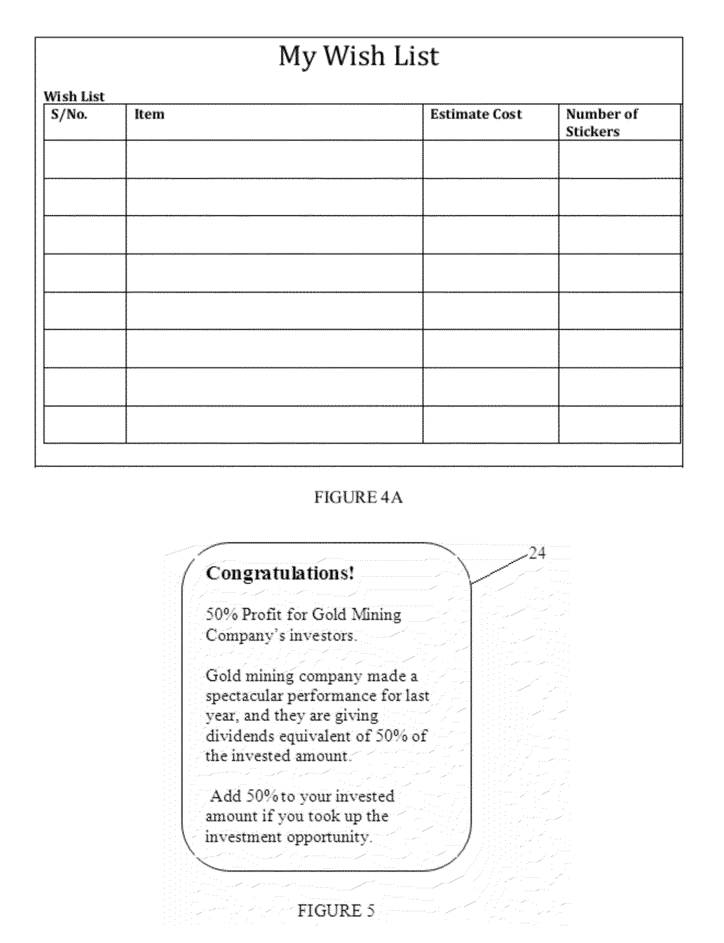

To ensure a minimum of 10% of savings rate, 10% of the tokens in the planner are “saving tokens” that are differentiated by special colour or design. The saving tokens can only be placed in saving account worksheet. The tokens in the planner are usually arranged in sequence of 10, with every 1^{st} or 10^{th} token being the special saving token. The user should be given the token in the same sequence as the arrangement of the tokens. In today modern world, this saving account is also commonly described as Financial Freedom Account which is represented in FIG. 4 which is to be described later.

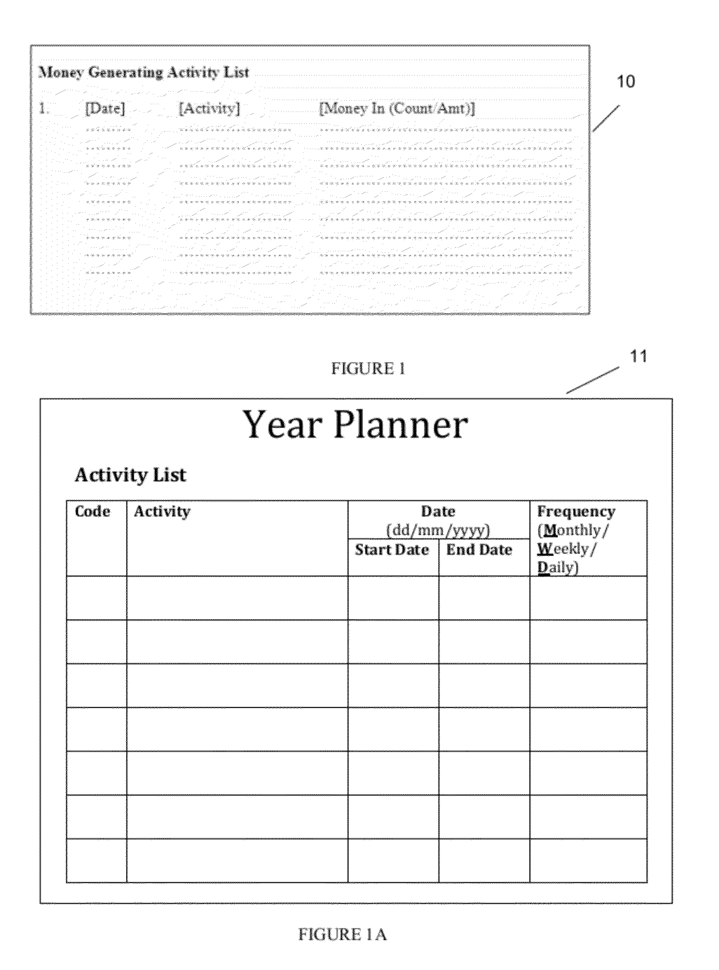

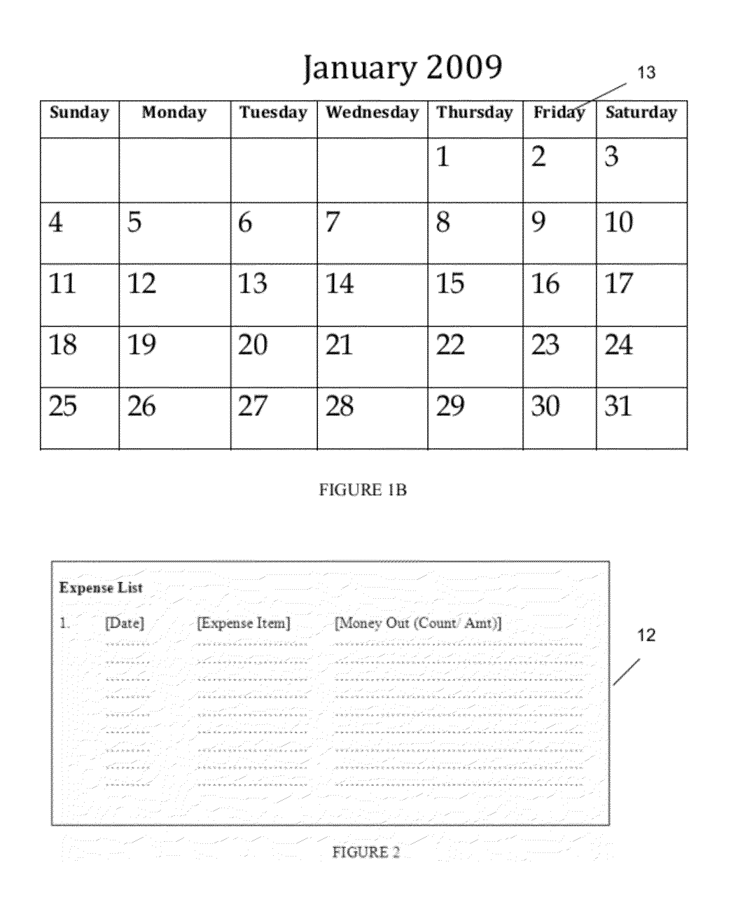

Prior to commencing use of our proposed financial education planner, it may be advantageous to have the user listing out his money-generating activities and list it in a sheet (10) such as that shown in FIG. 1 for ease of determining one's income amount to be proportionately represented in the planner. For the same reason, expenses items may be listed in a sheet (12) such as that shown in FIG. 2 for ease of budgeting out-goings. These two lists may be extracted from a general compilation of all activities in a Year Planner (11) shown in FIG. 1A before being extracted to each of the money-generating and expenses lists. Further, the expenses items wish list of objectives to be achieved by the saving effort may be listed as that shown in FIG. 4A.

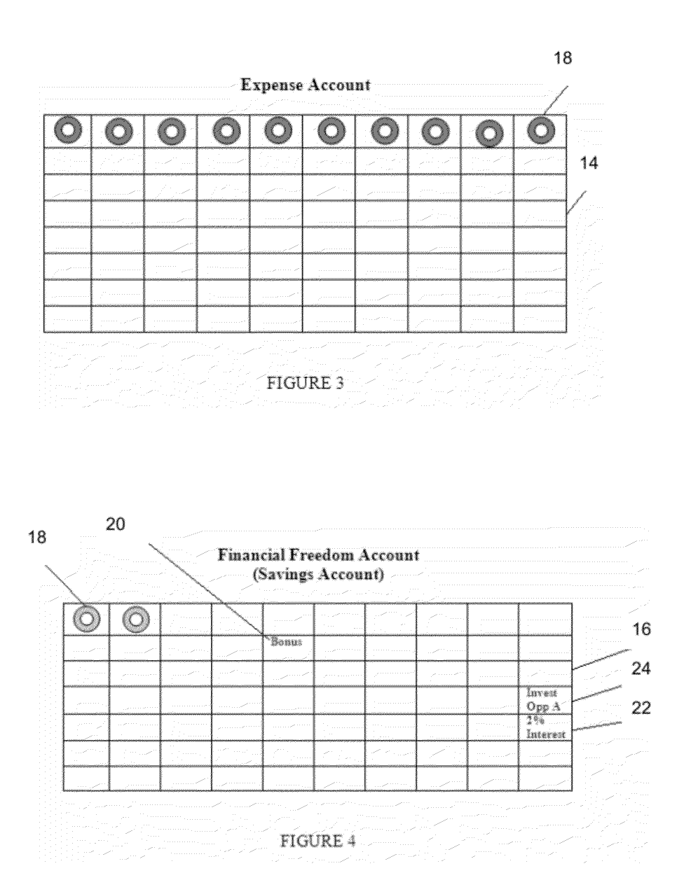

The financial education planner according to our invention comprises at least an income worksheet (13) shown in FIG. 1B, an expense account worksheet (14) shown in FIG. 3, at least a savings account worksheet (16) shown in FIG. 4, and a plurality of tokens (18) representing monetary denominations. The tokens (18) are affixable on the worksheets (14, 16). The expense account worksheet (14) and savings account worksheet (16) may have tabular layout, e.g. divided into array of boxes or cells, allowing the affixing of the tokens (18). Alternatively, the expense account worksheet (14) and savings account worksheet (16) may have calendar layout, e.g. divided into array of boxes or cells representing periodical units, e.g. each box represents each day of a month. Such a calendar view page enables the affixing of the tokens (18) thereunto on a periodical basis, i.e. on a daily, weekly or monthly basis, depending on the particular calendar page view. Each of the worksheets may include columns for indicating date, activity description, income, totals for the expenses and savings respectively, bonus (20) and interest (22) received, etc. FIG. 4 shows an example of a savings account worksheet having two tokens affixed as savings.

In one preferred embodiment, the income worksheet shows the source of tokens given to the user. It is likely to be in calendar layout as shown in FIG. 1B for the user to indicate the activities that earn the user the income over a periodical basis. The activities can be classes attended by children or jobs the adults worked. The intention of the income worksheet is for the user to watch and then plan the type and number of activities to achieve the desirable income or tokens. The main source of income should come from the activities the user had planned and completed. Other source of income or token can be given as gifts on special events like birthdays, or awarded for good conducts or performance, example on completing all planned activities in the worksheet over a defined period. The income worksheet can indirectly help to develop the user's emotional intelligence and winner's mindset.

As the tokens (18) are gradually affixed onto the worksheets, specially-marked boxes on the worksheet may be provided at predetermined intervals. These specially-marked boxes may be indicated for milestone reward purposes, such as bonus or interest pay-offs entitling the user to have more tokens in play. Accordingly, when the number of tokens affixed on the savings worksheet reaches a particular marked box, reward in the form of bonus issue of additional tokens may be provided as indicated. A record of the bonuses received may be recorded on conveniently sized Bonus cards (24) such as that shown in FIG. 5.

Other examples of bonuses from the bonus cards are:
Double amount in savings account;
100% increase to invested amount (mainly design for older user who needs to define the invested amount before the card is read;
25% increase to invested amount;
10% loss to invested amount;
100% loss to invested amount, etc.

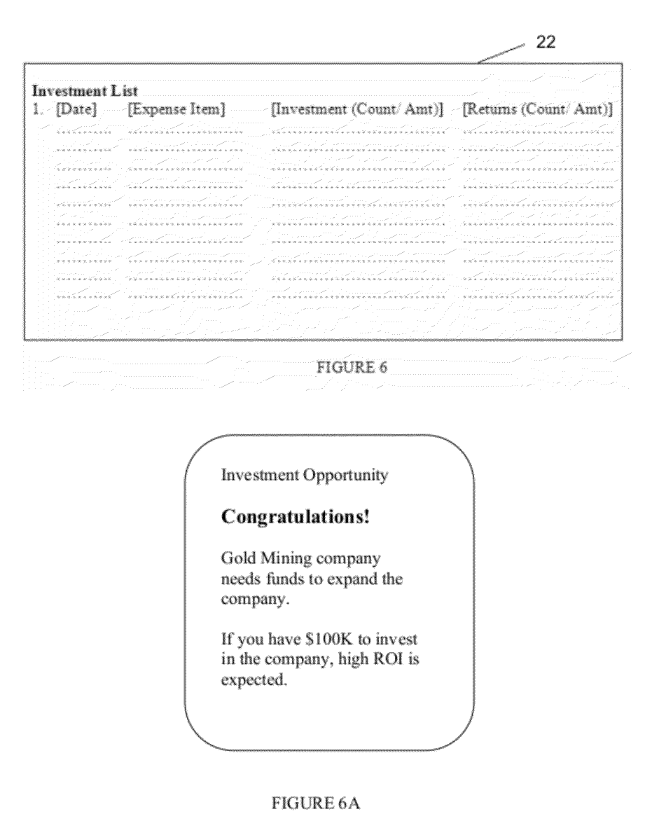

Alternatively, reward in the form of interest earned on saved tokens may be provided in the form of additional tokens payable upon the accumulated savings having been retained for a predetermined period and for each such predetermined periodic intervals. Another option for reward is to make available investment options upon a number of tokens being successfully accumulated on the savings account worksheet to reach a predetermined threshold. As the tokens made available for investment are essentially taken out of the savings pool and, hence, would not be available for bonus or interest rewards, details of the particular investment made is preferably made in a separate Investment worksheet (22), such as the example shown in FIG. 6. FIG. 6A shows an example of a bonus card for an investment opportunity.

Other examples of investment opportunities are:
Fixed Deposit of 10% interest;
Stocks;
Index;
Property;
Commodities, etc.

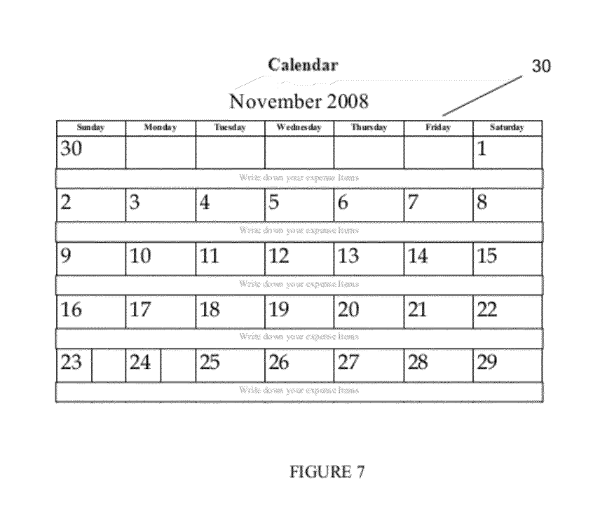

For an element of pleasant surprise, the reward scheme is not made known or disclosed to the person until the predetermined threshold is reached. The reward may also be provided in the form of approved purchase of products or services desired by the person once a predetermined amount of tokens is saved. FIG. 7 shows an example of a calendar form of worksheet (30) in monthly view whereupon the tokens may be affixed on a daily basis.

Another option is to provide the tokens in the form of an adhesive label, or a plastic bubble or blister with an adhesive bottom to affix onto the worksheet. When the token is spent or used, the expenditure may be indicated by pricking the bubble or blister to burst with a sound and/or feel effect. The tokens may also be provided in the form of stickers printed with suitable monetary denomination and optionally provided with an desirable iconic feature such as a favourite character, idol, symbol, etc. and may be purchased in boxes. Higher monetary denomination may be issued to older user to mimic the reward system in real life, where higher man rates provided for more experience employee. Higher monetary denomination can also help the user's mathematics.

It should be noted that while the above worksheets of the planner is described based on physical worksheets, it is obvious that such worksheets may be provided virtually or electronically such as in the form of a spreadsheet or worksheet which may be displayed on a screen of a computer or portable electronic gadgets, and worked by a computer or gadget user. Similarly, the worksheets may be embedded into or based on web pages. Other electronic forms that may be adapted to provide the worksheets are in the form of electronic tables, page file, applets, servlets and like routines.

Having the worksheets in electronic may have the added advantage in that when the savings accumulated reach a predetermined amount whereby investment options become available, a hyperlink may be provided to lead the user to a webpage containing advisory and information on investment options. This and other features and embodiments of our invention may be presented in many other variations, substitution or modifications thereof which are obvious to a skilled person without departing from the essence and working principles of the invention. Such variations are to be considered as falling within the letter and scope of the following claims.

1. A financial education planner kit comprising:
at least one income worksheet;
at least one expense account worksheet;
at least one savings account worksheet; and
a plurality of tokens representing monetary denominations, with a minimum of 10% thereof marked as saving tokens, said tokens being affixable on the aforesaid worksheets,
wherein said expense account worksheet and savings account worksheet have layouts enabling said tokens to be affixed thereto on a periodic basis.

2. A financial education planner according to claim 1, wherein the expense and savings account worksheets each include boxes or cells representing periodic units of time for affixing said tokens, said boxes or cells forming a calendar layout.

3. A financial education planner according to claim 2, wherein said boxes or cells are provided on the savings account worksheet at predetermined intervals on the worksheets.

4. A financial education planner according to claim 1, wherein the worksheets include columns for indicating a date; activity description; income; totals for expenses and savings, respectively; and a bonus.

5. A financial education planner according to claim 1, wherein the tokens are indicated with a suitable monetary denomination.

6. A financial education planner according to claim 5, wherein the tokens are provided as bubble or blister elements which burst with a noticeable effect when punctured.

7. A financial education planner according to claim 1, wherein, when the number of tokens accumulated on the savings account worksheet reaches a predetermined threshold, investment options for said accumulated tokens become available to the user.

8. A financial education planner according to claim 1, wherein the worksheets are provided as in a virtual and electronic form including electronic page files.

9. A financial education planner according to claim 8, wherein, when the number of tokens accumulated on the savings account worksheet reaches a predetermined threshold, investment options for said accumulated tokens become available to the user; and wherein the investment options include hyper-linking to web pages containing advice and information on said investment options.

10. A financial education planner according to claim 1, wherein additional worksheets are included to provide for a breakdown of the expenses into categories including at least one of a:
Gifts account
Education account
Long Term savings account
Entertainment account

11. A method for educating a person to be judicious in the dispensation of income, said method comprising the step of using a financial education planner which comprises
a worksheet for an expenditure account,
a worksheet for a savings account, and
tokens affixable on said worksheets to indicate respective expenditure and savings on a periodic basis,
wherein not more than 90% of the person's income is allocated to the expense account with the balance of not less than 10% of the income allocated to the savings account.

12. A method for educating a person according to claim 11, wherein more than 10% of the person's income is allocated to the savings account.

13. A method for educating a person according to claim 11, wherein a reward in the form of bonus issue of additional tokens is provided when accumulated savings reaches a predetermined threshold amount as indicated on the savings account worksheet at periodic intervals.

14. A method for educating a person according to claim 11, wherein a reward in the form of interest, represented by additional tokens, is provided when accumulated savings have been retained for a predetermined periodic interval of the savings account worksheet.

15. A method for educating a person according to claim 11, wherein options for investment are provided when the accumulated savings, represented by the number of tokens affixed to the savings account worksheet, attains a predetermined threshold.

16. A method for educating a person according to claim 13, wherein the reward is not disclosed to the person until the predetermined threshold is reached.

17. A method for educating a person according to claim 11, wherein a reward in the form of an approved purchase of a product or service desired by the person is enabled once a predetermined threshold amount of tokens is saved.

18. A method for educating a person according to claim 15, wherein the investment options include investment advice and information linked to a website.

19. The financial education planner according to claim 5, wherein the tokens are provided with an iconic image.

20. The financial education planner according to claim 6, wherein the noticeable effect is selected from the group consisting of a sound, a visual effect and a tactile effect.
